(19) United States
(12) Patent Application Publication
(10) Pub. No.: US 2011/0279973 A1
(43) Pub. Date: Nov. 17, 2011

(54) BEZEL LOCK FOR AN INFORMATION HANDLING SYSTEM

(75) Inventors: Kevin Daniel Terwilliger, Austin, TX (US); Bradley Michael Lawrence, Austin, TX (US); Richard Andrew Crisp, Austin, TX (US); Timothy Uys, Austin, TX (US)

(73) Assignee: DELL PRODUCTS L.P., Round Rock, TX (US)

(21) Appl. No.: 12/777,755

(22) Filed: May 11, 2010

(51) Int. Cl. G06F 1/16; A47B 81/00

(52) U.S. Cl. 361/679.58; 312/223.2

(57) ABSTRACT

A bezel lock system for use with an information handling system including one or more components disposed in a server chassis mounted in a bay of a rack system is disclosed. The bezel lock system may include a rack ear associated with the server chassis, a slam latch, a bezel, and a rotating lock. The slam latch may be disposed at least in part within the rack ear and configured to automatically engage the rack ear with the rack system as the server chassis slides into the rack bay. The rack ear may only be disengaged from the rack system if the slam latch is released. The bezel may be configured to attach to the front of the server chassis and prevent removal of any components through the front panel of the server chassis. The rotating lock may be associated with the bezel and restrict removal of the bezel from the server chassis while in the locked position. The lock may be further configured to restrict release of the slam latch while in the locked position.

### TECHNICAL FIELD

The present disclosure relates in general to information handling systems, and more particularly to bezel locks for an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The term rack server refers to an information handling system component designed to be mounted in a rack system. Rack servers may also be called rack-mounted servers. The rack system includes two or more vertical posts providing a frame for mounting rack servers and/or other components of the information handling system. The rack system provides a plurality of mounting slots known as bays configured to hold a rack server and/or another component. A rack system may allow multiple servers to be stacked vertically, providing a smaller foot print and simplifying cable connections between the servers.

A simple rack system may include one or more chassis attached to the vertical posts by screws. Some rack systems include rails and/or additional components for mounting hardware components. For example, slide rails may allow a chassis to slide in and/or out of the rack without the need to remove screws. As another example, a rack system may allow a user to slide a rack server into existing rails without any additional connectors. In those examples, the rack server is usually retained in the rack by a simple latch. Operation of the latch allows the rack server to be removed by the user.

### SUMMARY

In accordance with one embodiment of the present disclosure, an bezel lock system for use with an information handling system is disclosed. The bezel lock system may include a rack ear associated with the server chassis, a slam latch, a bezel, and a rotating lock. The slam latch may be disposed at least in part within the rack ear and configured to automatically engage the rack ear with the rack system as the server chassis slides into the rack bay. The rack ear may only be disengaged from the rack system if the slam latch is released. The bezel may be configured to attach to the front of the server chassis and prevent removal of any components through the front panel of the server chassis. The rotating lock may be associated with the bezel and restrict removal of the bezel from the server chassis while in the locked position. The lock may be further configured to restrict release of the slam latch while in the locked position.

In accordance with another embodiment of the present disclosure, a rack system for an information handling system is disclosed. The rack system may include two or more posts, a server chassis, a rack ear associated with the server chassis, a slam latch, a bezel, and a rotating lock. The server chassis may house one or more components of the information handling system and be configured for mounting to one of the two or more posts. The slam latch may be disposed at least in part within the rack ear and configured to automatically engage the rack ear with the rack system as the server chassis slides into the rack bay. The rack ear may only be disengaged from the rack system if the slam latch is released. The bezel may be configured to attach to the front of the server chassis and prevent removal of any components through the front panel of the server chassis. The rotating lock may be associated with the bezel and configured to restrict removal of the bezel from the server chassis while in the locked position. The lock may be further configured to restrict release of the slam latch while in the locked position.

In accordance with yet another embodiment of the present disclosure, an information handling system is disclosed. The information handling system may include a motherboard configured for mounting one or more electronic components of the information handling system, a server chassis, one or more processors, a rack ear, a slam latch, a bezel, and a rotating lock. The server chassis may house the motherboard and be configured for mounting on a rack system defining a plurality of rack bays. The one or more processors communicatively coupled with associated memories and mounted on the motherboard. The rack ear may be associated with the server chassis. The slam latch may be disposed at least in part within the rack ear and configured to automatically engage the rack ear with the rack system as the server chassis slides into one of the plurality of rack bays. The rack ear may only be disengaged from the rack system if the slam latch is released. The bezel may be configured to attach to the front of the server chassis and prevent removal of any components through the front panel of the server chassis. The rotating lock may be associated with the bezel and configured to restrict removal of the bezel from the server chassis while in the locked position. The lock may be further configured to restrict release of the slam latch while in the locked position.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows an isometric view of a rack system used to house components of an information handling system, according to the teachings of the present disclosure;

FIG. 2 shows an isometric view of a rack system used to house components of an information handling system, according to the teachings of the present disclosure;

FIG. 3 shows an internal view of a bezel lock for a server chassis according to the teachings of the present disclosure; and

FIG. 4 shows an exploded view of the bezel lock from FIG. 3 among other components.

### DETAILED DESCRIPTION

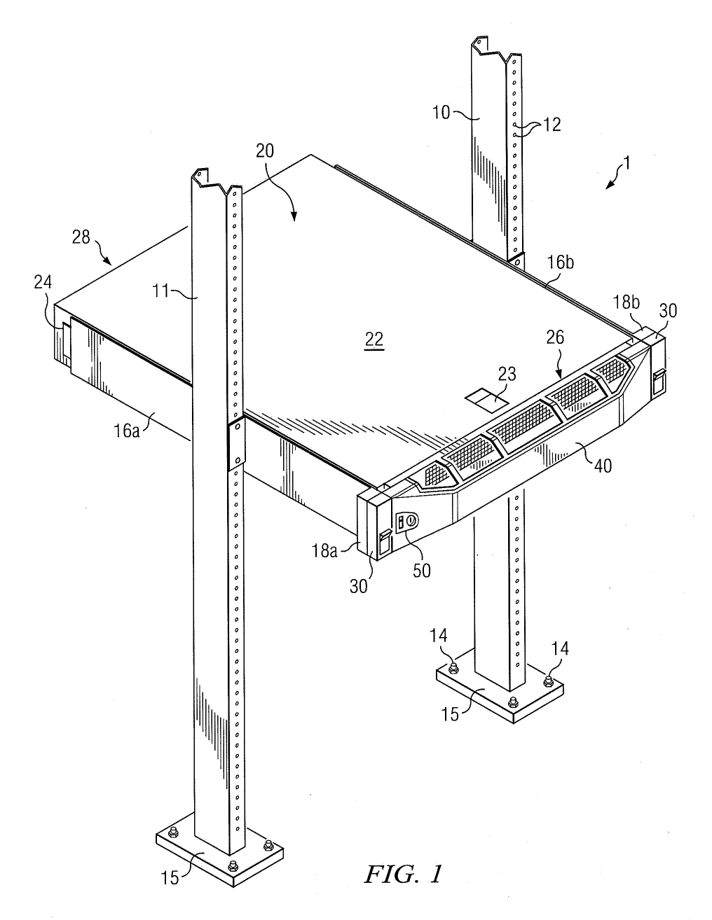

Preferred embodiments and their advantages are best understood by reference to FIGS. 1 through 4, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

FIG. 1 shows an isometric view of a rack system 1 including a chassis 20 mounted in a rack system, according to the teachings of the present disclosure. Rack system 1 may include posts 10 and 11 and a server 20. Although FIG. 1 shows a single server 20, rack system 1 may be part of an information handling system including any number of components, including servers, I/O devices, and/or storage devices.

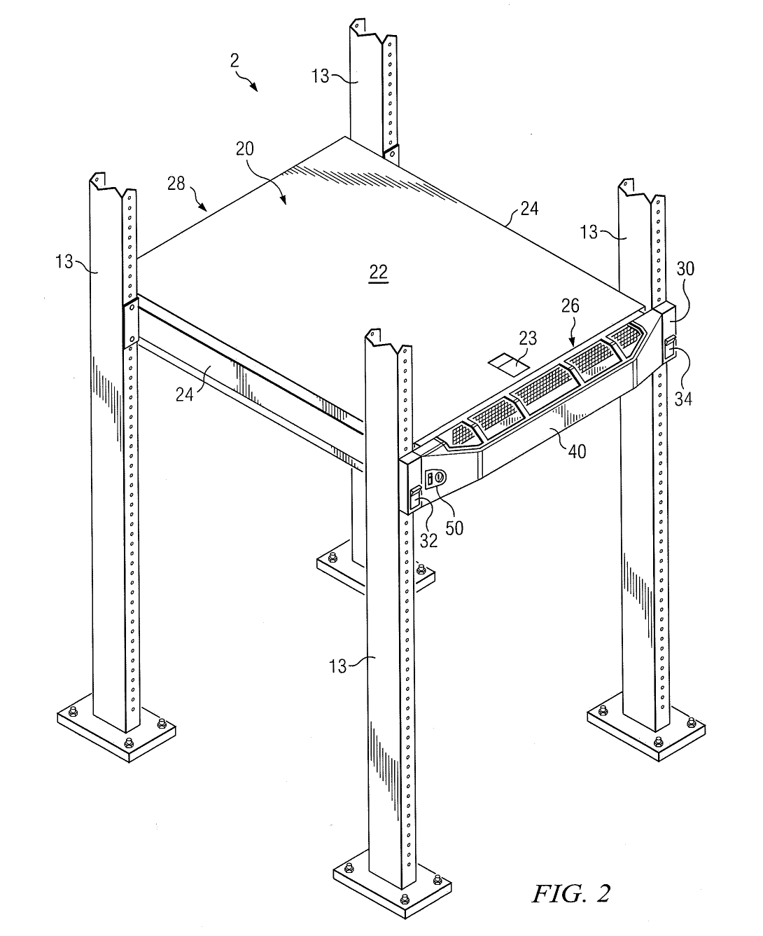

Posts 10 and 11 may include any component and/or device providing a structural support for components mounted in a rack system. For example, posts 10 and 11 may include vertical members with holes spaced for connecting components to posts 10 and 11. A component (e.g., server 20) may be mounted directly to posts 10 and 11 via holes 12. The component may be mounted by its front panel, or close to its center of gravity. In other examples, such as that shown in FIG. 1, the component may be mounted to rails 16a and 16b which are, in turn, attached to posts 10 and 11 using holes 12 so that the component is supported along its length. Rails may be used with either 2-post or 4-post rack systems (an example 4-post system is discussed in relation to FIG. 2).

Posts 10 and 11 may include one or more features and/or components configured to attach the posts to the ground and/or floor. For example, posts 10 and 11 may include feet 15. Feet 15 may include flat material defining holes. Bolts 14, pegs, and/or any other vertical member may extend through feet 15 to provide stability and/or attachment points.

Rails 16 may include any component, device, and/or feature of posts 10 and 11 configured to provide sliding support for a component of the information handling system. For example, rails 16 may function and appear like drawer slides in traditional cabinets and/or shelving systems. Rails 16 may be used for components that may be frequently removed and/or accessed. Rails 16 may serve to support a component in a position clear of posts 16 to allow inspection and/or maintenance.

Rails 16a and 16b may include associated tongues 18a and 18b. Tongues 18a and 18b may include any feature, device, and/or component of rails 16 configured to provide a retention force for components of the information handling system. For example, server 20 may slide into rails 18a and 18b. When server 20 is fully inserted some component and/or feature of the server chassis (e.g., rack ears 30) may make contact with tongues 18 to form a latch and/or other physical detent.

Server 20 may include one or more rack ears 30. Rack ears 30 may provide an attachment point between server 20 and posts 11 and 12 or rails 18. For example, rack ears 30 may include a latch configured to releasably attach to tongue 18 when they are pushed together. Rack ears 30 may include any device, feature, and/or component of server 20 and/or a chassis configured to attach to tongues 18. In some embodiments, rack ears 30 may attach to tongues 18 as server 20 slides into rails 16.

Some rack systems may be enclosed by front and/or rear doors, side panels, and or top panels (not expressly shown). Such enclosures, sometimes called cages, may be installed to reduce unauthorized access to the components of the information handling system. Cages may, however, reduce air flow to the components of the information handling system and, thus, interfere with the cooling and/or heat removal from those components. Rack systems without cages, such as rack system 1 shown in FIG. 1, may incorporate the teachings of the present disclosure to provide improved security.

For example, server 20 may be disposed within a chassis including a top panel 22, side panels 24, an open front 26, an I/O panel 28, and/or a bottom panel. The elements of the chassis may provide a housing for the electronic components of server 20 including mechanical and/or electronic connections, convenient packaging for server 20, and/or security restricting the removal of the components of server 20. For example, top panel 22 may include top latch 23 operable to restrict the removal of top panel 22. Top latch 23 may include a lock operable only by authorized users.

Server 20 may include a motherboard housing one or more processors, storage devices, etc. Server 20 may include a backplane and/or a midplane configured to provide mechanical and/or electronic connection for the electronic components. In some embodiments, server 20 may include hard drives, communication ports, flash cards, and/or additional components accessible through open front 26. In those embodiments, bezel 40 may provide additional security for server 20 and/or the information handling system by restricting the removal of components from server 20 through open front 26. Bezel 40 may be removable so that authorized users may access and/or remove components of server 20 through open front 26.

Bezel 40 may include any component, device, and/or feature of the chassis of server 20 configured to attach to open front 26. For example, bezel 40 may include a solid sheet of material. In another example, bezel 40 may include a cage or lattice structure allowing air flow but restricting the removal of components through open front 26. Bezel 40 may be removable so that authorized users may access the components of server 20 through open front 26.

Bezel 40 may include an associated lock 50. Lock 50 may be configured to retain bezel 40 when engaged. Lock 50 may interface with rack ear 30 and/or any other part of the chassis of server 20. In some embodiments, lock 50 may interface with some feature and/or component of rack system 1 rather than server 20.

FIG. 2 shows an isometric view of a rack system 2 for use with an information handling system, according to the teachings of the present disclosure. Rack system 2 includes four vertical posts 13. Rack system 2 may include rails and/or slides configured to mount server 20 to posts 13. FIG. 2 also shows rack ears 30 associated with the chassis of server 20. Rack ears 30 may include latches 32 and 34.

Latches 32 and 34 may be configured to retain rack ears 30 and/or the chassis of server 20 in place with respect to rack system 2. For example, latches 32 and 34 may include any mechanical fastener configured to join rack ears 30 to posts 13 and to allow regular and/or easy removal of rack ears 30 from posts 13. If rack ears 30 are fixed to the chassis of server 20, latches 32 and 34 may also allow the regular and/or easy removal of server 20 from posts 13. In some embodiments, a keeper and/or a strike may be present on or in association with posts 13 to engage with latches 32 and 34.

Latches 32 and 34 may include a slam latch. A slam latch may be engaged by the sliding action of the chassis of server 20 into rails 18 (as shown in FIG. 1). Typically, a slam latch may be spring-loaded, as in a doorknob or a file cabinet drawer, so that it operates by “slamming”. For example, when a door is slammed shut, the latch in the doorknob may engage without further action by a user. In embodiments of the present disclosure including a slam latch, rack ears 30 may be engaged by slam latches 32 and 34 upon the “slamming” of the chassis into rack system 1 and/or 2.

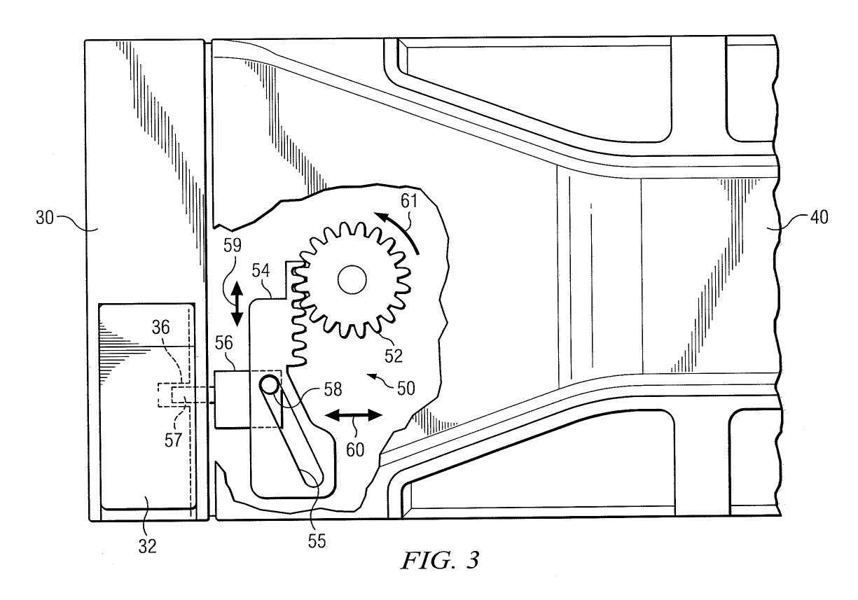

FIG. 3 shows an internal view of one embodiment of a bezel lock 50 for a server chassis, according to the teachings of the present disclosure. Lock 50 may include any device, feature, and/or component associated with bezel and/or the chassis of server 20 configured to retain bezel 40 against the chassis adjacent open front 26. As discussed above, bezel lock 50 may provide security against the removal of components of server 20 through open front 26. In the embodiment shown in FIG. 3, bezel lock 50 may also provide security against the removal of server 20 from the rack system (1 or 2).

Bezel lock 50 may include a gear 52, a pinion 54, and a leg 56. The rotation of gear 52 may drive pinion 54. As bezel lock 50 is engaged by rotation (shown by curved arrow 61), pinion 54 may be driven vertically (shown by arrow 59). As pinion 54 translates up and down, a peg 58 on leg 56 may slide within a slot 55 of pinion 54. The motion of peg 58 may cause leg 56 to translate horizontally (shown by arrow 60). As leg 56 translates horizontally, post 57 may engage a hole 36 associated with latch 32. While post 57 is present in hole 36, latch 32 may be obstructed from operation.

In other embodiments, bezel lock 50 may include various features and/or components configured to restrict the removal of other parts of the chassis of server 20. For example, bezel lock 50 may operate to block the operation of top latch 23 while engaged. Blocking the operation of top latch 23 may increase security by making it more difficult to access the interior of the chassis of server 20. In other embodiments, bezel lock 50 may operate to enable and/or disable various electronic components of server 20. In other embodiments, the removal of bezel 40 may trigger an alert and/or an alarm for a manager and/or monitor of the information handling system.

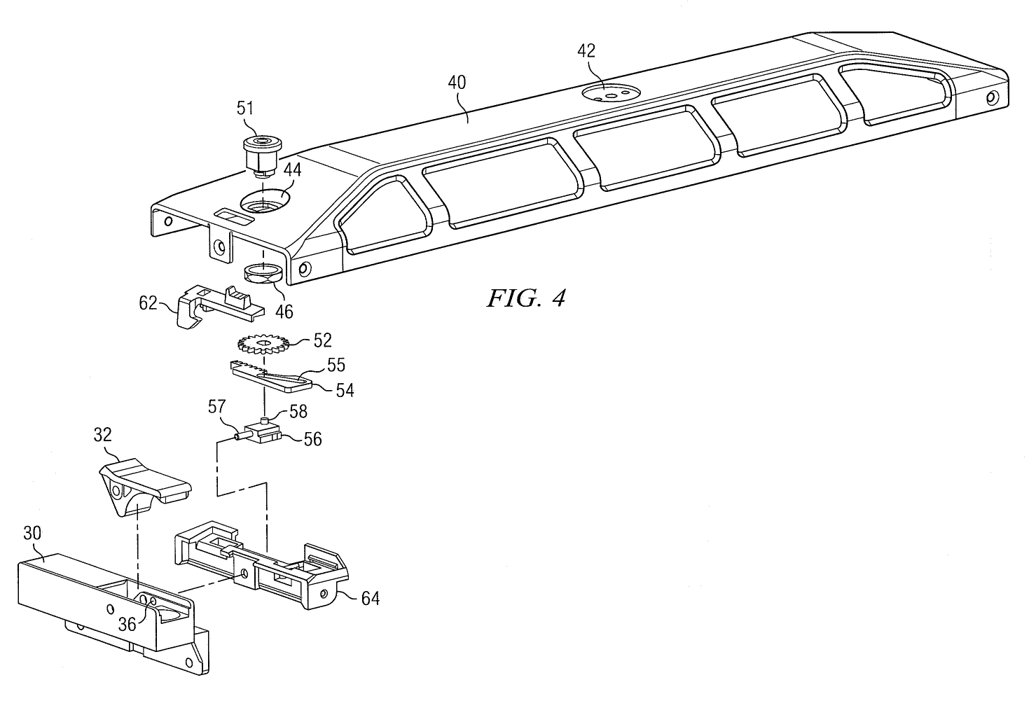

FIG. 4 shows an exploded view of bezel lock 50 in accordance with teachings of the present disclosure. As more fully discussed in relation to FIG. 3, the rotation of gear 52 drives pinion 54 and leg 56. As shown more fully in FIG. 4, gear 52 rotates along with the barrel 51 of bezel lock 50. Barrel 51 may be retained in bezel 40 using nut 46. Bezel 40 may include recess 42. Recess 42 may provide a mounting feature allowing a user to insert and/or mount a logo and/or brand symbol.

The various components of bezel lock 50 may be housed, at least in part, in a lock housing 64. Lock housing 64 may be any component, device, and/or feature of bezel 40 configured to retain the components of bezel lock 50 and to allow their motion as described above. For example, lock housing 64 may include a molded piece of plastic and/or formed metal.

FIG. 4 also shows various features of rack ear 30 and latch 32. Rack ear 30 includes hole 36 which aligns with a similar hole in latch 32. As discussed above, when post 57 extends through hole 36 into latch 32, latch 32 may not be actuated by a user. Latch 32 may include latch handle 33 and latch body 62. Latch handle 33, when actuated in the absence of post 57, moves latch body 62 vertically and allows the removal of server 20 from rack system 1 or 2.

Although the figures and embodiments disclosed herein have been described with respect to bezel locks for information handling systems, it should be understood that various changes, substitutions and alternations can be made herein without departing from the spirit and scope of the disclosure as illustrated by the following claims. For example, although the bezel lock 50 of FIG. 3 includes specific linkages and members, persons having ordinary skill in the art may be able to design alternative arrangements of members or alternative actions. As another example, bezel lock 50 may be associated with the rack system rather than with each individual server chassis.

What is claimed is:

1. A bezel lock system for use with an information handling system including one or more components disposed in a server chassis mounted in a bay of a rack system, the bezel lock system comprising:
a rack ear associated with the server chassis;
a slam latch disposed at least in part within the rack ear, the slam latch configured to automatically engage the rack ear with the rack system as the server chassis slides into the rack bay;
wherein the rack ear may only be disengaged from the rack system if the slam latch is released;
a bezel configured to attach to the front of the server chassis, the bezel preventing removal of any components through the front panel of the server chassis; and
a rotating lock associated with the bezel, the lock configured to restrict removal of the bezel from the server chassis while in the locked position;
the lock further configured to restrict release of the slam latch while in the locked position.

2. A bezel lock system according to claim 1, further comprising a second rack ear and a second slam latch associated with the second rack ear.

3. A bezel lock system according to claim 1, further comprising:
a pinion gear rotating along with the lock;
a rack driven by the rotation of the pinion gear; and
a pin extending and retracting from the bezel into the rack ear;
the pin blocking release of the slam latch while extended into the rack ear;
wherein the pin is extended into the rack ear while the lock is in the locked position.

4. A bezel lock system according to claim 1, further comprising a pin configured to block the release of the slam latch while the lock is in the locked position.

5. A bezel lock system according to claim 4, further comprising the pin configured to extend from the bezel into the rack ear as the lock is rotated to the locked position.

6. A bezel lock system according to claim 4, further comprising:
the pin configured to extend from the bezel into the rack ear as the lock is rotated to the locked position; and
a recess formed in the rack ear, the recess configured to receive the pin when extended from the bezel as the lock is rotated to the locked position.

7. A rack system for use with an information handling system, the rack system comprising:
two or more posts defining a plurality of rack bays;
a server chassis housing one or more components of the information handling system and configured for mounting on the two or more posts;
a rack ear associated with the server chassis;
a slam latch disposed at least in part within the rack ear, the slam latch configured to automatically engage the rack ear with one of the two or more posts as the server chassis slides into one of the plurality of rack bays;
wherein the rack ear may only be disengaged from the one of the two or more posts if the slam latch is released;
a bezel configured to attach to the front of the server chassis, the bezel preventing removal of any components through the front panel of the server chassis; and
a rotating lock associated with the bezel, the lock configured to restrict removal of the bezel from the server chassis while in the locked position;
the lock further configured to restrict release of the slam latch while in the locked position.

8. A rack system according to claim 7, further comprising a second rack ear and a second slam latch associated with the second rack ear.

9. A rack system according to claim 7, further comprising:
a pinion gear rotating along with the lock;
a rack driven by the rotation of the pinion gear; and
a pin extending and retracting from the bezel into the rack ear;
the pin blocking release of the slam latch while extended into the rack ear;
wherein the pin is extended into the rack ear while the lock is in the locked position.

10. A rack system according to claim 7, further comprising a pin configured to block the release of the slam latch while the lock is in the locked position.

11. A rack system according to claim 7, further comprising the pin configured to extend from the bezel into the rack ear as the lock is rotated to the locked position.

12. A rack system according to claim 7, further comprising:
the pin configured to extend from the bezel into the rack ear as the lock is rotated to the locked position; and
a recess formed in the rack ear, the recess configured to receive the pin when extended from the bezel as the lock is rotated to the locked position.

13. A rack system according to claim 7, further comprising:
a removable top panel associated with the server chassis; and
a top latch restricting the removal of the top panel when the top latch is engaged;
wherein the rotating lock is further configured to restrict release of the top latch while the rotating lock is in the locked position.

14. An information handling system comprising:
a motherboard configured for mounting one or more electronic components of the information handling system;
a server chassis housing the motherboard and configured for mounting on a rack system defining a plurality of rack bays;
one or more processors communicatively coupled with associated memories, the one or more processors mounted on the motherboard;
a rack ear associated with the server chassis;
a slam latch disposed at least in part within the rack ear, the slam latch configured to automatically engage the rack ear with the rack system as the server chassis slides into one of the plurality of rack bays;
wherein the rack ear may only be disengaged from the rack system if the slam latch is released;
a bezel configured to attach to the front of the server chassis, the bezel preventing removal of any components through the front panel of the server chassis; and
a rotating lock associated with the bezel, the lock configured to restrict removal of the bezel from the server chassis while in the locked position;
the lock further configured to restrict release of the slam latch while in the locked position.

15. An information handling system according to claim 14, further comprising a second rack ear and a second slam latch associated with the second rack ear.

16. An information handling system according to claim 14, further comprising:
a pinion gear rotating along with the lock;
a rack driven by the rotation of the pinion gear; and
a pin extending and retracting from the bezel into the rack ear;
the pin blocking release of the slam latch while extended into the rack ear;
wherein the pin is extended into the rack ear while the lock is in the locked position.

17. An information handling system according to claim 14, further comprising a pin configured to block the release of the slam latch while the lock is in the locked position.

18. An information handling system according to claim 14, further comprising the pin configured to extend from the bezel into the rack ear as the lock is rotated to the locked position.

19. An information handling system according to claim 14, further comprising:
the pin configured to extend from the bezel into the rack ear as the lock is rotated to the locked position; and
a recess formed in the rack ear, the recess configured to receive the pin when extended from the bezel as the lock is rotated to the locked position.

20. An information handling system according to claim 14, further comprising:
a removable top panel associated with the server chassis; and
a top latch restricting the removal of the top panel when the top latch is engaged;
wherein the rotating lock is further configured to restrict release of the top latch while in the locked position.
